(19) United States
(12) Patent Application Publication
(10) Pub. No.: US 2026/0039080 A1
(43) Pub. Date: Feb. 5, 2026

(54) HANDLING AID FOR ASSEMBLING ELECTRICAL RIBBON CABLES

(71) Applicant: SARTORIUS LAB INSTRUMENTS GMBH & CO. KG, Goettingen (DE)

(72) Inventor: Heyko HOLST, Goettingen (DE)

(21) Appl. No.: 19/354,180

(22) Filed: Oct. 9, 2025

Related U.S. Application Data
(63) Continuation of application No. PCT/EP2024/057473, filed on Mar. 20, 2024.

(30) Foreign Application Priority Data
Apr. 13, 2023 (DE) 20 2023 101 871.8

(51) Int. Cl. H01R 43/26

(52) U.S. Cl. CPC H01R 43/26

(57) ABSTRACT

A handling aid (10) for assembling electrical ribbon cables (20) has two clamping jaws (11, 12) hinged to each other about a pivot axis (41), with clamping surfaces facing each other. The clamping jaws together form a clamping mouth, into which, in an open state in which the clamping surfaces are angled to each other, a ribbon cable (20) can be inserted and in which, in a closed state in which the clamping surfaces are parallel to each other, the ribbon cable can be clamped. Each clamping jaw has a front section at one end, a gripping section at the other end, and a connecting section arranged therebetween. Flat clamping surface sections (111/121, 112/122, 113/123) are angled relative to one another and are aligned perpendicular to a pivot axis plane common to the corresponding clamping surface sections. The pivot axis lies in the pivot axis plane.

### CROSS-REFERENCE TO RELATED APPLICATION

This is a Continuation of International Application PCT/EP2024/0057473, which has an international filing date of Mar. 20, 2024, and the disclosure of which is incorporated in its entirety into the present Continuation by reference. This Continuation also claims foreign priority under 35 U.S.C. § 119(a)-(d) to and also incorporates by reference, in its entirety, German Patent Application DE 20 2023 101 871.8 filed on Apr. 13, 2023.

### FIELD

The invention relates to a handling aid for assembling electrical ribbon cables, comprising two clamping jaws hinged to each other about a pivot axis and having clamping surfaces facing each other, said clamping jaws together forming a clamping mouth, into which, in an open state in which the clamping surfaces are angled to each other, a ribbon cable to be mounted can be inserted and in which, in a closed state in which the clamping surfaces are parallel to each other, the ribbon cable can be clamped.

### BACKGROUND

Such handling aids are generally known in the form of flat pliers or flat tweezers.

In electronics, the use of ribbon cables for wired signal transmission is common practice. Ribbon cables come in various designs. They often consist of a large number of strands, each of which is made of a plastic-coated wire, with the individual strands arranged parallel to each other in a plane and connected to each other in a material-locking manner. However, there are also other designs, such as foil cables or so-called flexible printed circuit boards. All these and other designs are to be understood here under the term “ribbon cable.” For electrical contact, ribbon cables are assembled with special connectors. Typically, these are rectangular plastic blocks that extend across the entire width of the cable at one end. However, cable ends stiffened with resin, for example, which function as connectors, are also known. Based on different technologies, these connectors provide an input-side connection option for the ribbon cable. The cable is often clamped between two sub-blocks that have contact points for the individual strands of the ribbon cable. On the output side, connector pins or sockets are usually provided, which define a thrust direction perpendicular to the transverse direction of the block or the ribbon cable, in which the connector can be pushed towards a correspondingly shaped mating connector to form the electrical contact.

This insertion process, which must be carried out at several points during the assembly of complex electronic devices such as precision scales, is not without its challenges. Space is often limited and mating connectors, which are fixed to circuit boards, for example, are difficult to reach. In addition, typical ribbon cable connectors, which are often intended for one-time, permanent contact, offer only a small and usually ergonomically unfriendly surface for the installer's fingers to grip. In practice, an assembly technique has become established in which the ribbon cable is bent immediately behind the connector in order to provide the installer's hand with a contact surface when inserting the connector into the mating connector, via which the installer can apply force in the direction of insertion. However, kinking the ribbon cable can easily cause damage, especially in the case of delicate foil cable designs.

The use of flat pliers or flat tweezers applied transversely to the longitudinal extension of the cable, with which the cable is gripped across its entire width immediately behind the connector, has only proven helpful in exceptional cases. It is difficult to apply the pressure, with the necessary precision, that is required to carry out the insertion process transversely to the longitudinal extension of the tool. In addition, the extension of the handles of the pliers or tweezers, which can easily collide with other components, makes it difficult to position the tool.

DE 20 2012 101 070 U1 discloses punching pliers for ribbon cables which, after removal of the detachably fixed punching blade, are basically suitable as assembly pliers, but with the disadvantages described above.

DE 100 05 315 A1 discloses a clamp-like protective cover for ribbon cables. Clamping the ribbon cable in the area immediately behind the connector effectively extends the rigid connector, which increases the contact surface for the installer's fingers. However, the known protective cover is not suitable as an assembly aid for inserting a ribbon cable fitted with a plug into a mating connector fixed on a circuit board and requiring the ribbon cable to be guided largely parallel to the surface of the circuit board, which is why its use as an assembly aid is not mentioned at all in the aforementioned publication.

### SUMMARY

One object of the present invention is to provide an improved assembly aid for ribbon cables, which in particular facilitates the insertion of a plug fixed to the cable into a corresponding mating plug in confined spaces.

In a first variant of the invention, this object is achieved, in accordance with a first formulation, in that each clamping jaw has at least three clamping jaw sections, namely a front section at one end, a gripping section at the other end, and a connecting section arranged between the front section and the gripping section, and corresponding, essentially flat clamping surface sections which are angled relative to one another and which are aligned perpendicular to a pivot axis plane associated to the respective clamping jaw and common to the corresponding clamping surface sections, wherein the pivot axis lies in said pivot axis plane.

In a second variant of the invention, the object is alternatively achieved, in accordance with a further formulation, in that each clamping jaw has at least two clamping jaw sections, namely a front section at one end and a gripping section at the other end, and corresponding, essentially flat clamping surface sections which are angled relative to each other, wherein the clamping surface sections of the gripping section each carry, on their sides facing away from the respective adjacent clamping surface section and positioned off-center to one side, at least one hinge leg of a hinge, with which the clamping jaws are hinged to each other.

Further embodiments are the subject of the dependent claims.

With the tool according to the invention as described in the first variant above, a ribbon cable can be gripped from the side, similar to flat tweezers. The longitudinal extension of the ribbon cable runs essentially transverse to the longitudinal extension of the tool (defined by the longitudinal extension of the clamping mouth from the hinge point to the free ends of the clamping jaws) and essentially parallel to the pivot axis. However, in contrast to flat-nose pliers, the clamping surface of the tool according to the invention is divided into several clamping surface sections that are angled relative to each other and adjacent to each other in the longitudinal direction of the gripped ribbon cable. In other words, the clamped ribbon cable follows a stepped course in its longitudinal direction, namely the stepped course of the clamping surface. For example, and particularly preferably, the front section and the rear section, referred to here as the gripping section for reasons explained below, can be designed to be essentially parallel to each other, with both sections connected to each other by the slanted connecting section between them. If such a tool is applied immediately behind the connector of the ribbon cable, the clamped ribbon cable runs largely parallel and in close proximity to the circuit board on which the mating connector is fixed during the process of inserting it into the mating connector. In the connecting section, it is guided away from the circuit board and then transitions into the gripping section, which is further away from the circuit board and runs essentially parallel to it. In other words, the use of the tool according to the invention temporarily stiffens the ribbon cable in a shape that, on the one hand, is optimally adapted to the force required for the insertion process near the connector and, on the other hand, offers sufficient space for the installer's fingers to grip the cable away from the connector. This shape allows the tool according to the invention to be gripped in the clamping area of the cable itself and, unlike flat tweezers or flat pliers, for example, does not have to be gripped by separate grip elements that extend laterally at a distance from the cable. In this way, the point of application of the force required for insertion, i.e., the point of contact for the installer's fingers, and the point of action of this force, i.e., the front end of the plug that is inserted into the mating connector, can largely lie on a line extending in the direction of force flow. Separate lateral gripping elements can be completely dispensed with. In particular, the installer's fingers can engage with the rear clamping jaw section or clamping surface section, which is therefore referred to here as the gripping section.

As an alternative to the described preferred embodiment with three clamping surface sections, the invention can in principle also be used with more than three clamping surface sections. Cases with four or more clamping surface sections, i.e., cases in which more than two connecting sections angled relative to each other extend between the front section and the gripping section, are suitable when particularly complicated spatial conditions exist.

The skilled person will understand that the terms “angled,” “stepped,” and “substantially flat” as they relate to the clamping surface or its sections are to be understood broadly here and also include rounded, corrugated, and textured embodiments.

In the second variant of the invention mentioned above, the longitudinal extensions of the ribbon cable and the tool are aligned in the same direction. Here, the pivot axis runs transversely to the longitudinal direction of the ribbon cable and lies in particular in the cable plane itself. This means that the functional pivot axis must not be realized over its entire length by a spatial-physical pivot axis. Rather, the rear edge of the gripping section must be predominantly free and may only carry a hinge at a location that is as small as possible and off-center, with which hinge the two clamping jaws are hinged to each other. This location is preferably positioned at the edge. It is considered advantageous to construct the (functional) hinge from two (spatial-physical) partial hinges, which are arranged on both sides of the rear edge of the clamping jaw's gripping sections. In this case, the ribbon cable must be threaded between the partial hinges for insertion into the tool. If only one edge-mounted (partial) hinge is provided, the cable can also be inserted laterally, i.e., transversely to its longitudinal direction, into the gap (to be provided for this purpose) between the rear edges of the gripping sections.

The function of the handling aid according to the second invention variant corresponds analogously to that of the first invention variant, apart from the cable insertion process described above. The possible modifications discussed in this context can also be transferred to the second variant of the invention without any restrictions. Likewise, unless expressly stated otherwise, the embodiments described below can be applied to both variants of the invention.

The design according to the invention also makes it possible to dispense with a large lateral protrusion of the tool in comparison to the flat cable being gripped. Instead, the longitudinal extension of the tool can be reduced to the width of the flat cable to be installed. The tool according to the invention therefore fits into any installation space in which the cable to be mounted can also be accommodated and is therefore ideally suited for use in spatially restricted conditions. This applies somewhat more to the first variant of the invention than to the second, in which a larger lateral projection must be provided for the hinge or its two partial hinges.

To optimize for spatially limited conditions, a preferred embodiment of the invention provides that each clamping jaw is formed from a sheet material. In particular, each clamping jaw can be designed as a bent sheet metal or as being formed from plastic, for example as an injection-molded part. This minimizes the thickness expansion of the tool according to the invention and essentially adapts it to the expansion of the ribbon cable to be mounted. The skilled person will recognize that, when selecting the material and dimensioning the clamping jaws, the only important factor is that the resulting tool is sufficiently rigid in the closed state to be able to transmit the thrust force required to insert the plug into a mating connector without significant deformation of its own.

In the first variant of the invention, it is preferably provided that only the gripping sections or only the front sections or, if present, only the connecting sections each carry, on their sides facing each other in the open state, one hinge leg of a hinge with which the clamping jaws arc hinged to each other. Due to the stepped nature of the clamping surface or the angled arrangement of its clamping surface sections, it is not possible to provide a (spatial-physical) pivot axis extending across the entire width of the tool. Rather, it must extend along only one pair of sections. The choice of the gripping sections as carriers of a corresponding hinge has proven to be particularly advantageous in practice. However, it is also feasible that the hinge is located in the area of the front sections or in the area of the connecting sections.

Although it was explained above that a particular advantage of the tool according to the invention is that its longitudinal extension can be reduced essentially to the width of the ribbon cable to be clamped, at least in the area of the hinge, the width of the (closed) tool must protrude beyond the cable by at least the width of the hinge. It is particularly preferred that the clamping jaw sections carrying the hinge legs protrude with a leg support area arranged on their side carrying the respective hinge leg, in particular in the first variant of the invention, beyond the immediately adjacent clamping jaw section or sections. In other words, the hinge is deliberately offset slightly to the side (relative to the cable) (in the first variant of the invention) or to the rear (in the second variant of the invention). This allows the hinge-side edges of the clamping surfaces to always maintain a distance from each other determined by the size of the offset when closing, so that the cable is not excessively squeezed locally when the tool is closed.

The hinge itself can be designed as a film hinge, for example. This allows the clamping jaws to be designed as a single piece, especially in plastic-based embodiments.

Selling handling aids according to the invention as a set is particularly advantageous economically, since the tools, which are very simple and inexpensive to produce, can be used either as disposable items together with a ribbon cable, to whose dimensions they are optimally matched, or as devices optimized for different cables and adapted to different spatial conditions.

Further details and advantages of the invention are apparent from the following specific description and the drawings.

### BRIEF DESCRIPTION OF THE DRAWINGS

The drawings show:

FIG. 1: a handling aid according to the invention in accordance with a first variant in the open state with a ribbon cable inserted,

FIG. 2: a handling aid according to the invention in accordance with the first variant in the closed state with a ribbon cable inserted, shown in side view,

FIG. 3: a handling aid according to the invention in accordance with the first variant in the closed state with a ribbon cable inserted, in a top view.

FIG. 4: a handling aid according to the invention in accordance with a second variant in the open state with a ribbon cable inserted,

FIG. 5: a handling aid according to the invention in accordance with the second variant in the open state with a ribbon cable inserted, in a side view, and

FIG. 6: a handling aid according to the invention in accordance with the second variant in the closed state with a ribbon cable inserted, in a top view.

### DETAILED DESCRIPTION

Identical reference numbers in the figures indicate identical or analogous elements.

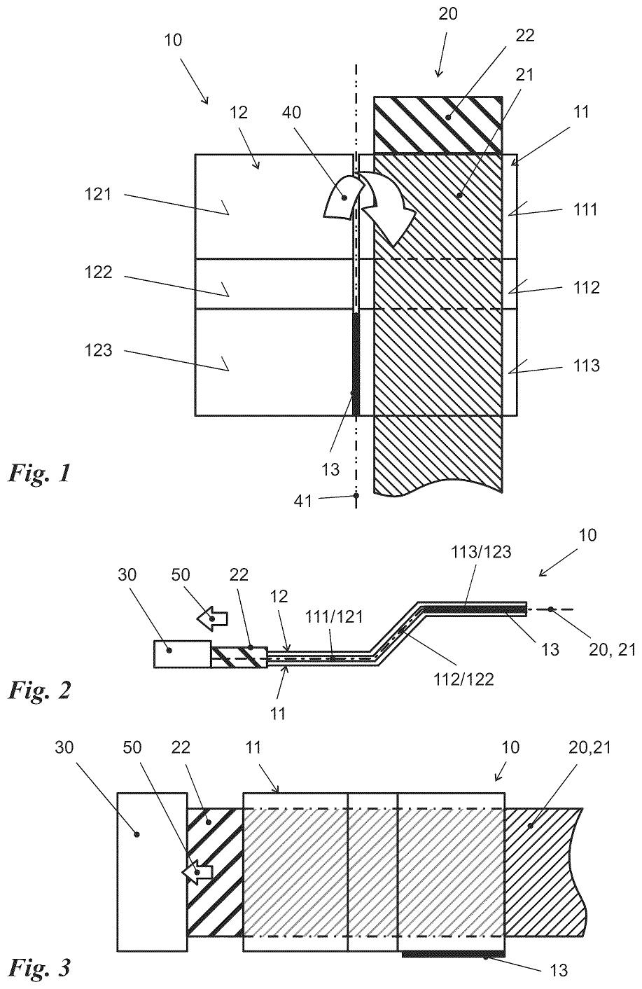

FIG. 1 shows a highly schematic representation of a handling aid 10 according to a first variant of the invention in the expanded state, i.e., in the open state. The same handling aid 10 is also shown in FIGS. 2 and 3, in each case in the collapsed state, i.e., in the closed state, in FIG. 2 in a side view and in FIG. 3 in a top view. The handling aid 10 essentially consists of two clamping jaws 11, 12 and a hinge 13 connecting them. With reference to FIG. 2, one of the clamping jaws 11, 12 shall be referred to here as the lower clamping jaw 11 and the other as the upper clamping jaw 12, simply for convenience and without this being restrictive in any way.

The surfaces of the clamping jaws 11, 12 facing each other when closed are referred to here as clamping surfaces. According to the invention, they are divided into several (in the embodiment shown, exactly three) clamping surface sections, namely a front section 111 or 121, a connecting section 112 or 122, and a gripping section 113 or 123. As can be seen in FIG. 2, the clamping surface sections 111/121, 112/122, 113/123 are arranged at an angle to each other. In the embodiment shown, the front sections 111/121 in particular are oriented essentially parallel to the gripping sections 113/123, with the connecting section 112/122 connecting them forming a slanted step.

In the embodiment shown, the hinge 13 is arranged between the facing edges of the gripping sections 113/123. However, in other embodiments, it could also be arranged between the connecting sections 112/122 or between the front sections 111/121. In any case, it allows pivoting of the clamping jaws 11, 12 relative to each other, as indicated by the pivot arrow 40 and the pivot axis 41 in FIG. 1.

For handling, as shown in FIG. 1, a ribbon cable 20 is placed on the clamping surface of the lower clamping jaw 11 of the handling aid 10 when the handling aid is in the unfolded or open state. The ribbon cable 20 comprises the actual cable 21 and a plug 22, which is arranged at one end of the actual cable 21. In the embodiment shown, the plug 22 is designed as a plastic block into which the actual cable 21 terminates. However, it is also feasible to stiffen the wire ends locally, e.g., with a hardened resin. Inside the plug 22, contact elements are provided which contact the individual conductor strands of the cable 21 and form an interface for corresponding contact elements of a mating plug 30 (see FIGS. 2 and 3). Details of these contact elements are not shown in the figures because they are known to those skilled in the art and are not directly relevant to the present invention.

As shown in FIG. 1, the ribbon cable 20 is preferably placed on the clamping surface of the lower clamping jaw 11 such that its plug 22 rests against the front edge of the front section 111 of this clamping surface. This ensures correct alignment of the ribbon cable 20 relative to the handling aid 10.

The handling aid 10 is then closed in accordance with the swivel arrow 40 by folding the upper clamping jaw 12 around the hinge 13. In this way, as can be seen in particular in FIG. 2, the ribbon cable 20 is clamped between the clamping jaws 11, 12 and thereby assumes the stepped profile defined by the clamping jaws. Functionally, in this state, the ribbon cable is temporarily stiffened in the area of the handling aid 10.

The handling aid 10, in particular the area in which the gripping sections 113/123 of the clamping surface are located, can serve as an easily accessible point of contact for the fingers of a technician, which are not shown in the figures. The technician can exert pressure on the clamping jaws 11, 12 in the closing direction and secure the ribbon cable 20 in its temporarily stiffened position. At the same time, the technician can very easily and precisely apply a thrust force in the longitudinal direction of the ribbon cable 10, via which the plug 22 can be inserted into the mating connector 30 fixed, for example, on a circuit board, as indicated in FIGS. 2 and 3 by the thrust arrow 50. Thanks to the handling aid 10 according to the invention, kinking of the ribbon cable is reliably prevented when this thrust force is applied. FIG. 3 shows the same situation as FIG. 2, but in a top view of the action.

After assembly, the installer releases the pressure acting on the grip area 113/123 so that the upper clamping jaw 12 swivels away from the lower clamping jaw 11 around the hinge 13 and the handling aid 10 can thus be opened. This then corresponds again to the situation in FIG. 1, in which the handling aid 10 can be removed from the then-installed ribbon cable 20 without any further difficulties.

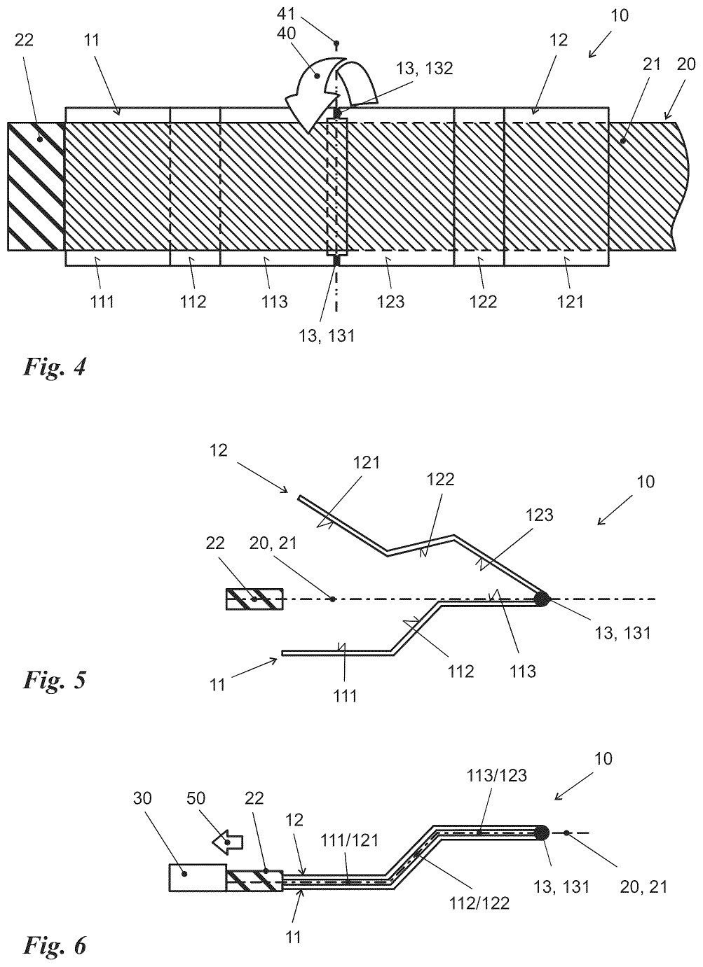

FIG. 4 shows a highly schematic representation of a handling aid 10 according to a second variant of the invention in a fully opened state. The same handling aid 10 is also shown in FIGS. 5 and 6, each in side view, in FIG. 5 in an incompletely unfolded open state and in FIG. 6 in a collapsed state, i.e., in the closed state. Here too, the handling aid 10 essentially consists of two clamping jaws 11, 12 and a hinge 13 connecting them. With reference to FIG. 5, one of the clamping jaws 11, 12 shall also be referred to here as the lower clamping jaw 11 and the other as the upper clamping jaw 12, simply for convenience and without this being restrictive in any way.

The surfaces of the clamping jaws 11, 12 facing each other when closed are also referred to here as clamping surfaces. According to the invention, they are divided into several (in the embodiment shown, exactly three) clamping surface sections, namely a front section 111 or 121, a connecting section 112 or 122, and a gripping section 113 or 123. As can be seen in FIGS. 5 and 6, the clamping surface sections 111/121, 112/122, 113/123 are arranged at an angle to each other. In the embodiment shown, the front sections 111/121 in particular are oriented essentially parallel to the gripping sections 113/123, with the connecting section 112/122 connecting them forming a slanted step.

In the embodiment shown, the hinge 13 is composed of two partial hinges 131, 132, which are arranged between the rear edges of the gripping sections 113/123 facing each other. In particular, they are positioned at both ends of the rear edge of the gripping section, so that there is a gap between them through which a flat ribbon cable 20 can be threaded and thus inserted between the clamping surfaces of the clamping jaws 11, 12. The (functional) hinge 13 allows pivoting of the clamping jaws 11, 12 relative to each other, as indicated by the pivot arrow 40 and the pivot axis 41 in FIG. 4. The ribbon cable 20 comprises the actual cable 21 and a plug 22, which is arranged at one end of the actual cable 21. In the embodiment shown the plug 22 is designed as a plastic block into which the actual cable 21 terminates. However, it is also feasible to stiffen the wire ends locally, e.g., with a hardened resin. Inside the plug 22, contact elements are provided which contact the individual conductor strands of the cable 21 and form an interface for corresponding contact elements of a mating connector 30 (see FIG. 6). Details of these contact elements are not shown in the figures because they are known to those skilled in the art and are not directly relevant to the present invention.

As shown in FIG. 4, the ribbon cable 20 is preferably placed in the handling aid 10 such that its plug 22 rests against the front edge of the front section 111 of this clamping surface. This ensures that the ribbon cable 20 is correctly aligned relative to the mounting aid 10.

The handling aid 10 is then closed in accordance with the pivot arrow 40 by folding the upper clamping jaw 12 around the hinge 13. In this way, as can be seen in particular in FIG. 5, the ribbon cable 20 is clamped between the clamping jaws 11, 12 and, as shown in FIG. 6, takes on the stepped profile specified by them. Functionally, in this state, the ribbon cable is temporarily stiffened in the area of the handling aid 10.

The handling aid 10, in particular the area in which the gripping sections 113/123 of the clamping surface are located, can serve as an easily accessible point of contact for the fingers of a mechanic, which are not shown in the figures. A technician can exert pressure on the clamping jaws 11, 12 in the closing direction and secure the ribbon cable 20 in its temporarily stiffened position. At the same time, the technician can very easily and precisely apply a thrust force in the longitudinal direction of the ribbon cable 10, via which the plug 22 can be inserted into the mating connector 30 fixed, for example, on a circuit board, as indicated in FIG. 6 by the thrust arrow 50. Due to the handling aid 10 according to the invention, buckling of the ribbon cable 20 is reliably prevented when this thrust force is applied.

After assembly, the technician releases the pressure acting on the gripping section 113/123, so that the upper clamping jaw 12 pivots away from the lower clamping jaw 11 around the hinge 13 and the handling aid 10 can thus be opened. This then corresponds to the situation shown in FIG. 4. The handling aid can then be pulled back from the ribbon cable 20, which of course only works in cases where the rear end of the ribbon cable is free. In cases where this is not the case, the handling aid 10 cannot be used in the embodiment shown. However, a modification can be applied here in which the hinge 13 comprises or consists of only one of the partial hinges 131, 132. Instead of the other partial hinge 132, 131, this modification only has an extension of the gap intended for threading. This allows the ribbon cable 20 to be inserted from the side or the handling aid to be removed from the side of the cable.

Of course, the embodiments discussed in the specific description and shown in the figures are only illustrative examples of the present invention. In light of the disclosure herein, the skilled person is provided with a wide range of possible variations. In particular, the skilled person is largely free in the choice of materials. For example, the clamping jaws 11, 12 can be manufactured as bent sheet metal parts that are connected to each other with an adhesive strip acting as a film hinge. A one-piece embodiment made of injection-molded plastic is also feasible. Of course, more complex variants using more elaborate hinges 13 are also possible.

### LIST OF REFERENCE SYMBOLS

10 handling aid
11 (lower) clamping jaw
11 front section of the clamping surface of 11
112 connecting section of the clamping surface of 11
113 gripping section of clamping surface 11
12 (upper) clamping jaw
121 front section of the clamping surface of 12
122 connecting section of the clamping surface of 12
123 gripping section of the clamping surface of 12
13 hinge
20 ribbon cable
21 actual cable
22 plug
30 counter plug
40 Pivot arrow
41 pivot axis
50 thrust arrow

What is claimed is:

1. Handling aid for assembling electrical ribbon cables, comprising two clamping jaws hinged to each other about a pivot axis and having clamping surfaces facing each other,
wherein the clamping jaws together form a clamping mouth configured, in an open state in which the clamping surfaces are angled to each other, to receive a ribbon cable to be mounted and, in a closed state in which the clamping surfaces extend in parallel to each other, to clamp the ribbon cable,
wherein each clamping jaw has at least three clamping jaw sections, comprising a front section at one end, a gripping section at another end, and a connecting section arranged between the front section and the gripping section, and at least substantially flat clamping surface sections corresponding respectively to the clamping jaw sections, which are angled relative to one another and which are aligned perpendicular to a pivot axis plane associated to each respective clamping jaw and common to the corresponding clamping surface sections, and wherein the pivot axis lies in the pivot axis plane.

2. Handling aid according to claim 1,
wherein exclusively the gripping sections or exclusively the front sections or exclusively the connecting sections each carry, on sides thereof facing each other in the open state, one hinge leg of a hinge with which the clamping jaws are hinged to each other.

3. Handling aid according to claim 2,
wherein the clamping jaw sections carrying the hinge legs each have a leg support area arranged on the sides thereof carrying the respective hinge leg, which leg support areas protrude laterally beyond the clamping jaw sections adjoining the leg support areas.

4. Handling aid for assembling electrical ribbon cables, comprising two clamping jaws hinged to each other about a pivot axis and having clamping surfaces facing each other,
wherein the clamping jaws together form a clamping mouth, configured, in an open state in which the clamping surfaces are angled to each other, to receive a ribbon cable to be mounted and, in a closed state in which the clamping surfaces extend in parallel to each other, to clamp the ribbon cable,
wherein each clamping jaw has at least two clamping jaw sections, comprising a front section at one end and a gripping section at another end, and at least substantially flat clamping surface sections corresponding respectively to the clamping jaw sections, which are angled relative to each other, and
wherein the clamping surface sections of the gripping section each carry, on sides thereof facing away from the respective adjacent clamping surface section and positioned off-center to one side, at least one hinge leg of a hinge with which the clamping jaws are hinged to each other.

5. Handling aid according to claim 4,
wherein the clamping surface sections of the gripping section each carry, on sides thereof facing away from the respective clamping surface sections, two hinge legs positioned at edges of a hinge formed from two partial hinges spaced apart by a width of the flat ribbon cable to be mounted.

6. Handling aid according to claim 4,
wherein each clamping jaw has at least a third clamping jaw section, comprising a connecting section arranged between the front section and the gripping section and having a substantially flat clamping surface section angled relative to the clamping surface sections of the front section and the gripping section.

7. Handling aid according to claim 2,
wherein each hinge connecting the clamping jaws is configured as a film hinge.

8. Handling aid according to claim 4,
wherein each hinge connecting the clamping jaws is configured as a film hinge.

9. Handling aid according to claim 7,
wherein the clamping jaws are connected to each other in one piece.

10. Handling aid according to claim 8,
wherein the clamping jaws are connected to each other in one piece.

11. Handling aid according to claim 2,
wherein the hinge legs of at least one hinge are spring-loaded against each other in an opening direction of the clamping mouth.

12. Handling aid according to claim 4,
wherein the hinge legs of at least one hinge are spring-loaded against each other in an opening direction of the clamping mouth.

13. Handling aid according to claim 2,
wherein, in a closed position, each hinge forms an outer boundary of the handling aid.

14. Handling aid according to claim 4,
wherein, in a closed position, each hinge forms an outer boundary of the handling aid.

15. Handling aid according to claim 1,
wherein each clamping jaw is formed from a sheet material.

16. Handling aid according to claim 4,
wherein each clamping jaw is formed from a sheet material.

17. Handling aid according to claim 15,
wherein each clamping jaw is formed as a bent sheet metal or is molded from plastic.

18. Handling aid according to claim 16,
wherein each clamping jaw is formed as a bent sheet metal or is molded from plastic.

19. Handling aid according to claim 1,
wherein the front section and the gripping section of each clamping surface are parallel or at an angle of no more than 30° to each other.

20. Handling aid according to claim 4,
wherein the front section and the gripping section of each clamping surface are parallel or at an angle of no more than 30° to each other.

21. Handling aid according to claim 1,
wherein the front section and the connecting section of each clamping surface section are at an angle of between 120° and 150° to each other.

22. Handling aid according to claim 6,
wherein the front section and the connecting section of each clamping surface section are at an angle of between 120° and 150° to each other.
